(19) United States
(12) Patent Application Publication
(10) Pub. No.: US 2016/0183617 A1
(43) Pub. Date: Jun. 30, 2016

(54) METHOD FOR PREPARING CUSTOM-FITTED UNDERGARMENTS

(71) Applicant: Carlanda R. McKinney, Overland Park, KS (US)

(72) Inventor: Carlanda R. McKinney, Overland Park, KS (US)

(21) Appl. No.: 14/963,135

(22) Filed: Dec. 8, 2015

Related U.S. Application Data
(60) Provisional application No. 62/091,061, filed on Dec. 12, 2014.

(51) Int. Cl. A41H 3/00; G06T 19/20

(52) U.S. Cl. CPC A41H 3/007; G06T 19/20; G06T 2219/2016

(57) ABSTRACT

A computer-implemented method of creating custom fitted undergarments with the steps of (1) separating a two dimensional undergarment pattern into pattern pieces; (2) converting each undergarment pattern piece into a digital representation; (3) obtaining data about a body's size and shape in three dimensions; (4) creating a three dimensional digital avatar of the body using obtained data and (5) fitting the digital representation of the undergarment representation pieces to the three dimensional digital avatar of the body to create a custom fitted three dimensional undergarment design.

### BACKGROUND

The bra is one of the closest fitting garments worn by women, as it is generally designed to support the soft tissues of the breast so the garment is shaped to fit the contours of the body. Bras must generally also be comfortable to wear and aesthetically pleasing. It is estimated that nearly 70% of women wear bras that are incorrectly sized or poorly fitted.¹ Ill-fitting bras and insufficient breast support can lead to the development of musculoskeletal pain and inhibit women participating in physical activity. Greenbaum A R, Heslop T, Morris J: An investigation of the suitability of bra fit in women referred for reduction mammaplasty. Brit J Plast Surg 2004, 56(3):230-236.

While many women seek the guidance of in-store bra fitting professionals, the rise of Internet shopping has brought an increasing need for consumers to measure themselves rather than consulting experienced fitters. A quick internet search reveals that variations on the following procedure for calculating bra sizes is quoted on many retail sites and elsewhere: (1) Measure around the ribcage just under the bust in inches. (2) If the result is even add four, otherwise add five, this is the band size. (3) Measure around the bust at its fullest point. (4) Subtract the result of (2) from the result of (3). (5) Convert this number to a letter—this is the cup size. However, in practice, many consumers prefer to find their bra size though trial and error, which is expensive and inconvenient.

Generally, women have a poor ability to independently choose a well-fitted bra, which is not improved by trying on several bras or using bra-sizing measurements. Additionally, stock bra sizes do not result in a firm fit against the breast and body of all who wear them. As such, there is a need for a method to create bras customized to match the exact measurements and shape of the wearer.

### DETAILED DESCRIPTION

The present invention seeks to meet this need by providing a method of constructing a custom fit undergarment (bra) based on measurements obtained by the use of three dimensional (3D) body mapping. The method generally comprises the steps of: (1) converting bra designs into digital design images; (2) obtaining data defining the body's size and shape in three dimensions; (3) creating a body digital avatar using obtained data; and (4) fitting the digital design image to the client digital avatar.

The body digital avatar is created using obtain data by scanning the body using a TC2 brand body scanner or similar machine. The digital design image is fitted to the client digital avatar by using CAD software, such as Optitex CAD software or Gerber CAD software. The method further comprises electronically reading and recording the bra measurements from fitted 3D digital design image on body digital avatar. The method further comprises creating new two dimensional (2D) bra design pattern that corresponds to recorded 3D bra measurements. The method further comprises following new bra design pattern to create a bra custom fitted to the body.

The bra designs may be converted into digital designs using CAD technology that is known in the prior art such as optical scanning devices and software. The client measurements may be converted into a digital avatar using 3D optical scanning methods known in the prior art, such as a TC2 body scanner. The method further comprises a software application on a computer that is in communication with the optical scanning device for generation of the custom fitted bra pattern. The 2D pattern piece is generated from the 3D measurements by using commercially available software such as Optitex or Gerber which allows a user to convert a 3D design into a 2D pattern and print it out for manufacturing.

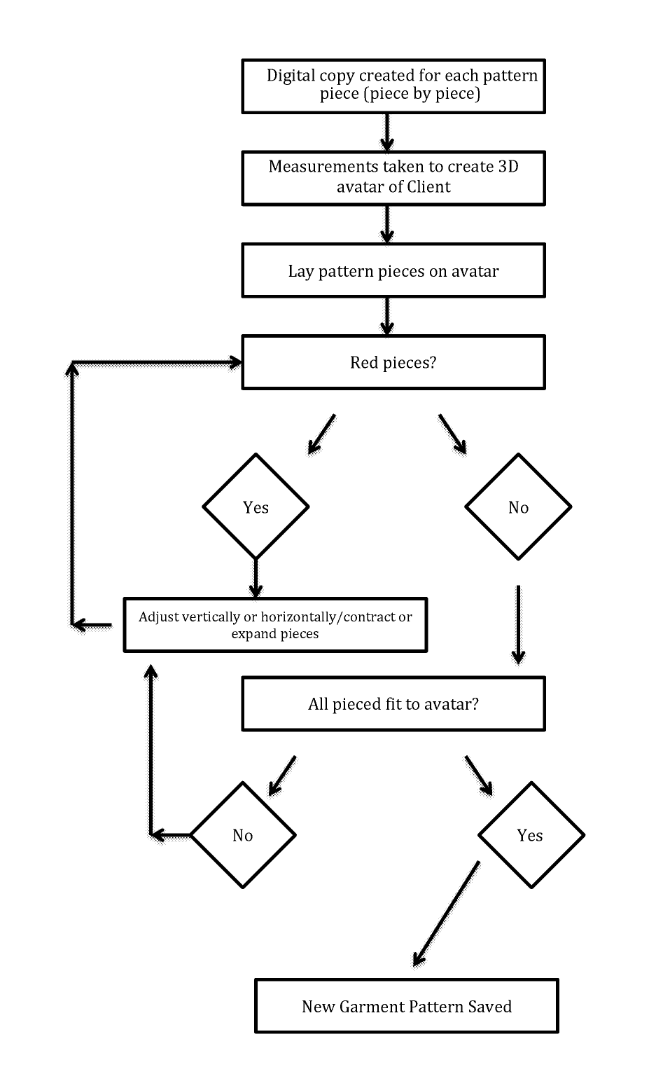

Turning to FIG. 1, the preferred embodiment using Optitex software is disclosed. First, the 3D avatar shows on the screen and so does a digital copy of each pattern piece. When the pattern is digitized, it is done so piece by piece, not as a whole garment. The user then drags and drops the digital pattern pieces to where they are supposed to be on the avatar. The user then expands or contracts that piece until it fits the avatar's measurements. The system will put a hue of red on the garment if it estimates that the fit will be too tight, but it does not adjust automatically. The user can adjust the pieces vertically or horizontally, bearing in mind that these aren't exclusive of each other because stretching one way too far will decrease the integrity of the garment. Once all of the pattern pieces have been fit to the avatar in this way, the newly adjusted garment is saved. The pattern is either printed off and sent to the manufacturer for production or sent in a digital form.

After construction, the bra may require a few minor manual adjustments if the fit isn't perfect. If a number of the same post production fit adjustments occur, the user can account for those during the digital fitting process.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A computer-implemented system for custom fitting undergarments comprising:
a. A first component configured to convert two dimensional undergarment pattern pieces into digital representations;
b. A second component configured to obtain data about a body's size and shape in three dimensions and create a three dimensional digital avatar of the body;
c. A third component configured to fit the digital representations of the undergarment pattern pieces to the digital avatar of the body;
d. A fourth component configured to record measurements of the fitted undergarment and create a two dimensional undergarment design pattern that corresponds to the measurements of the undergarment;
e. A processor; and
f. A computer-readable storage medium storing instructions that, when executed by the processor, cause the processor to implement the components.

2. The computer-implemented system of claim 1 where the first component converts two dimensional undergarment pattern pieces into digital representations using computer aided design.

3. The computer-implemented system of claim 1 wherein the second component obtains data about a body's size and shape in three dimensions using three dimensional optical scanning.

4. The computer-implemented system of claim 1 wherein the third component configured to fit the digital representations of the undergarment pattern pieces to the digital avatar of the body fits the undergarment pieces to the digital avatar by expanding or contracting vertically or horizontally each piece until it fits the avatar while still maintaining the integrity of the undergarment as a whole.

5. The computer-implemented system of claim 1 wherein the fourth component records measurements of the fitted undergarment and creates a two dimensional undergarment design pattern that corresponds to the measurements of the undergarment using computer aided design.

6. A computer-implemented method of creating custom fitted undergarments, the computer-implemented method comprising the steps of:
a. separating a two dimensional undergarment pattern into pattern pieces;
b. converting each undergarment pattern piece into a digital representation;
c. obtaining data about a body's size and shape in three dimensions;
d. creating a three dimensional digital avatar of the body using obtained data; and
e. fitting the digital representation of the undergarment representation pieces to the three dimensional digital avatar of the body to create a custom fitted three dimensional undergarment design.

7. The computer-implemented method of claim 6 further comprising electronically reading and recording the undergarment measurements from the digital representation of the fitted undergarment design.

8. The computer-implemented method of claim 7 further comprising creating a two dimensional undergarment design pattern that corresponds to the fitted digital representation of the undergarment design.

9. The computer-implemented method of claim 6 wherein the two dimensional undergarment design pattern pieces are converted into digital representations using computer aided design.

10. The computer-implemented method of claim 6 wherein the digital undergarment pieces are expanded or contracted vertically or horizontally until each piece fits the avatar while still maintaining the integrity of the undergarment as a whole.

11. The computer-implemented method of claim 6 wherein the data about a body's size and shape in three dimensions is obtained using an optical scanning device.
